(19) United States
(12) Patent Application Publication
(10) Pub. No.: US 2022/0300833 A1
(43) Pub. Date: Sep. 22, 2022

(54) FEATURE EXTRACTION DEVICE, TIME-SERIES DATA ANALYSIS SYSTEM, METHOD, AND PROGRAM

(71) Applicant: NEC Corporation, Minato-ku, Tokyo (JP)

(72) Inventor: Kazunori MIYOSHI, Tokyo (JP)

(73) Assignee: NEC Corporation, Minato-ku, Tokyo (JP)

(21) Appl. No.: 17/640,136

(22) PCT Filed: Sep. 6, 2019
(86) PCT No.: PCT/JP2019/035254

§ 371 Date: Mar. 3, 2022

(51) Int. Cl. G06N 5/02

(52) U.S. Cl. CPC G06N 5/022

(57) ABSTRACT

A feature extraction device 80 includes a feature extraction unit 81 which extracts a feature indicated by time-series data by machine learning using a recurrence plot generated from the time-series data.

### TECHNICAL FIELD

The present invention relates to a feature extraction device, a feature extraction method, and a feature extraction program for extracting a feature from time-series data, and to a time-series data analysis system and a time-series data analysis method for analyzing time-series data using the extracted feature.

### BACKGROUND ART

Time-series data is a series of values obtained by measuring temporal changes of a certain phenomenon continuously or at predetermined intervals, and the data includes various features such as the measured values themselves and changes in the values. Therefore, it is difficult to analyze the similarity/dissimilarity of any two time-series data or to extract a feature from the time-series data manually. Therefore, various methods have been proposed to extract all or part of the time-series data to analyze the similarity/dissimilarity of two time-series data and to extract a feature.

### Patent Literature

Patent literature 1 describes a device for extracting a feature of a one-dimensional time-series signal. The device described in patent literature 1 extracts a feature by analyzing a one-dimensional time-series signal based on a recurrence plot method and by calculating higher-order local autocorrelation coefficients from a two-dimensional image generated thereby. A method for analyzing quantitative time-series data using a recurrence plot is disclosed in non-patent literatures 1 and the like.

The recurrence plot is a diagram used in statistics and chaos theory, in which the time when the values are almost equal at a certain time is plotted as a point. The recurrence plot is used to discriminate the stationarity (weak stationarity) or non-stationarity of time-series data.

Patent literature 2 also describes a method for generating a feature for classifying an identification target into a predetermined class using a plurality of time-series data. In addition, patent literature 2 describes a method of generating secondary feature calculated by statistical processing for input data of each dimension of a plurality of dimensions when identifying temporal changes in data, and inputting the secondary feature to a discriminator such as a neural network or a support vector machine for machine learning.

### CITATION LIST

PTL 1: Japanese Patent Laid-Open No. 2008-116588
PTL 2: Japanese Patent Laid-Open No. 2018-005448

### Non-Patent Literature

NPL 1: Hirata, Y, “Recurrence plots: beyond visualization of time-series”, In Journal of the Institute for Mathematical Analysis, volume 1768, pages 150-162, 2011.

### SUMMARY OF INVENTION

### Technical Problem

In the calculation of the higher-order local autocorrelation coefficient described in patent literature 1, a threshold value is calculated from a histogram of a two-dimensional image generated by analyzing a one-dimensional time-series signal. Then, binary image information is generated by converting the two-dimensional image information into binary information based on the obtained threshold value. However, in this method, the order is limited to the second order and the displacement direction is limited to a 3×3 region. Therefore, there is a problem that the number of feature dimensions increases exponentially with the region size.

In addition, since the information obtained by the recurrence plot described in the non-patent literature 1 is only fragmentary data of the time-series data, it is difficult to say that the feature can be sufficiently extracted from the time-series data.

On the other hand, in the method described in patent literature 2, the data to be identified is converted into pattern data, and the pattern data is input to a discriminator to perform a predetermined identification. However, in the method described in patent literature 2, the feature is generated by focusing on the features of individual vertices in the time-series data, and it is difficult to say that other information is reflected in the feature. Therefore, it is desirable to be able to generate a feature that represent the global structure of the time-series data, taking into account the stationarity of the time-series data, etc., rather than features obtained only from individual vertices.

Therefore, it is an exemplary object of the present invention to provide a feature extraction device, a time-series data analysis system, a feature extraction method, a time-series data analysis method, and a feature extraction program that can extract a feature representing a global structure from time-series data.

### Solution to Problem

A feature extraction device according to the exemplary aspect of the present invention includes a feature extraction unit which extracts a feature indicated by time-series data by machine learning using a recurrence plot generated from the time-series data.

A time-series data analysis system according to the exemplary aspect of the present invention includes the above-described feature extraction device, and an analysis device which analyzes time-series data, wherein the analysis device includes an analysis target input unit which receives input of the time-series data to be analyzed, and a generation unit which generates a recurrence plot from the time-series data, and a result output unit which outputs an analysis result of the input time-series data using a feature extracted by the feature extraction unit.

A feature extraction method according to the exemplary aspect of the present invention, by a computer includes extracting a feature indicated by time-series data by machine learning using a recurrence plot generated from the time-series data.

A time-series data analysis method according to the exemplary aspect of the present invention includes extracting a feature indicated by time-series data by the above-described feature extraction method, receiving input of the time-series data to be analyzed, generating a recurrence plot from the time-series data, and outputting an analysis result of the input time-series data using the extracted feature.

A feature extraction program according to the exemplary aspect of the present invention causes a computer to execute a feature extraction process of extracting a feature indicated by time-series data by machine learning using a recurrence plot generated from the time-series data.

### Advantageous Effects of Invention

According to the exemplary aspect of the present invention, it is possible to extract a feature representing a global structure from time-series data.

### BRIEF DESCRIPTION OF DRAWINGS

FIG. 1 It depicts a block diagram showing a configuration example of an exemplary embodiment of a time-series data analysis system according to the exemplary aspect of the present invention.

FIG. 2 It depicts a flowchart showing an operation example of a feature extraction device.

FIG. 3 It depicts a flowchart showing an operation example of an analysis device.

FIG. 4 It depicts an explanatory diagram showing an example of a recurrence plot.

FIG. 5 It depicts a block diagram showing an overview of a feature extraction device according to the exemplary aspect of the present invention.

FIG. 6 It depicts a block diagram showing an overview of a time-series data analysis system according to the exemplary aspect of the present invention.

FIG. 7 It depicts a summarized block diagram showing a configuration of a computer for at least one exemplary embodiment.

### DESCRIPTION OF EMBODIMENTS

Hereinafter, exemplary embodiments of the present invention are described with reference to the drawings.

### Exemplary Embodiment 1

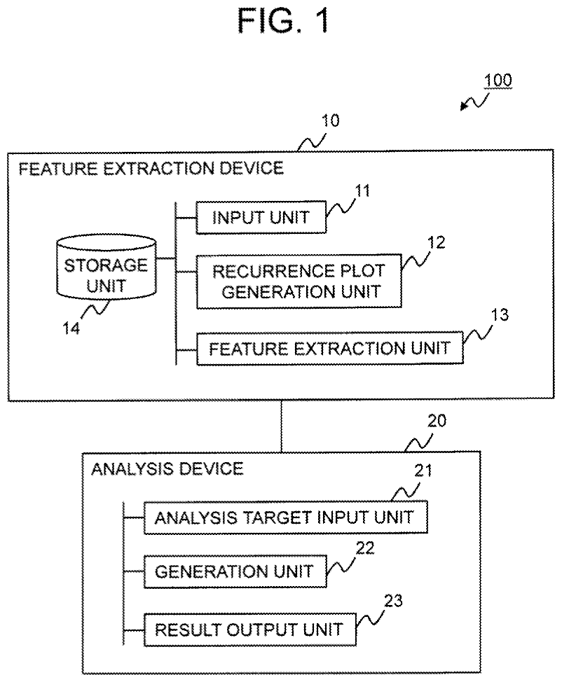

FIG. 1 is a block diagram showing a configuration example of an exemplary embodiment of a time-series data analysis system according to the exemplary aspect of the present invention. The time-series data analysis system 100 of the present exemplary embodiment comprises a feature extraction device 10 and an analysis device 20.

The feature extraction device 10 is a device for extracting a feature of time-series data. The feature extraction device 10 of this exemplary embodiment includes an input unit 11, a recurrence plot generation unit 12, a feature extraction unit 13, and a storage unit 14.

The input unit 11 receives input of time-series data. The dimension of the time-series data to be received is arbitrary and may be two-dimensional, three-dimensional, or more. For example, if the time-series data is stored in the storage unit 14 described below, the input unit 11 may receive input of the time-series data stored in the storage unit 14. Also, if the time-series data is stored in an external storage (not shown), the input unit 11 may receive input of the time-series data from the external storage through a communication line.

The input unit 11 may also directly receive input of a recurrence plot generated from the time-series data. In this case, the feature extraction device 10 may not include the recurrence plot generation unit 12 described below.

The recurrence plot generation unit 12 generates a recurrence plot from the input time-series data. The method of generating a recurrence plot from time-series data is widely known, and a detailed description is omitted. The recurrence plot generation unit 12 may generate a plurality of recurrence plots for each of a plurality of conditions in which an embedding dimension or a delay amount of is varied for the input time-series data. In this way, by having the recurrence plot generation unit 12 generate a recurrence plot for each of the plurality of conditions with different contents for the same time-series data, it becomes possible to generate a plurality of recurrence plots from the same kind of time-series data.

The feature extraction unit 13 extracts the feature indicated by the time-series data by machine learning using the recurrence plot. Specifically, the feature extraction unit 13 extracts the feature indicated by the time-series data by extracting the feature from the recurrence plot in a method similar to the method for performing image recognition by machine learning.

In the case where a plurality of recurrence plots is generated for each of a plurality of conditions (specifically, embedding dimension or delay amount) with different contents for the same time-series data, the feature extraction unit 13 may extract the feature indicated by the time-series data by machine learning using these plurality of recurrence plots. By machine learning using such a plurality of recurrence plots, it becomes possible to extract the assumed feature from the same type of time-series data.

The feature extraction unit 13 may not only extract the feature but also generate a model for identifying the recurrence plot (more specifically, the time-series data) by machine learning. The content of the machine learning performed by the feature extraction unit 13 is arbitrary, and includes, for example, principal component analysis, heterogeneous learning, and neural networks.

The storage unit 14 stores various information necessary for the feature extraction device 10 to perform processing and processing results. For example, the storage unit 14 may store various parameters used when the feature extraction unit 13 performs machine learning, and may store a feature extracted by the feature extraction unit 13. The storage unit 14 may also store the input time-series data and the generated recurrence plot. The storage unit 14 is realized, for example, by a magnetic disk or the like.

The input unit 11, the recurrence plot generation unit 12, and the feature extraction unit 13 are, for example, realized by a processor (for example, a CPU (Central Processing Unit), a GPU (Graphics Processing Unit)) of a computer that operates according to a program (feature extraction program).

For example, a program may be stored in the storage unit 14, and the processor may read the program and operate according to the program as the input unit 11, the recurrence plot generation unit 12 and the feature extraction unit 13 according to the program. Also, the functions of the feature extraction device 10 may be provided in a SaaS (Software as a Service) format.

In addition, in the present exemplary embodiment, since the feature extraction unit 13 performs machine learning using the recurrence plot as image data, the feature extraction unit 13 is realized by a GPU, it is possible to further improve the processing performance.

In addition, the input unit 11, the recurrence plot generation unit 12, and the feature extraction unit 13 may each be realized by dedicated hardware. Some or all of the components of each device may be realized by general-purpose or dedicated circuits, a processor, or a combination thereof. They may be configured by a single chip or by a plurality of chips connected through a bus. Some or all of the components of each device may be realized by a combination of the above-described circuits or the like and a program.

When some or all of each component of the feature extraction device 10 is realized by a plurality of information processing devices, circuits, or the like, the plurality of information processing devices, circuits, or the like may be centrally located or distributed. For example, the information processing devices, circuits, and the like may be implemented as a client-and-server system, a cloud computing system, and the like, each of which is connected through a communication network.

An analysis device 20 is a device that outputs the results of analyzing time-series data. The analysis device 20 includes an analysis target input unit 21, a generation unit 22, and a result output unit 23.

The analysis target input unit 21 receives input of time-series data to be analyzed. The analysis target input unit 21 may directly receive input of a recurrence plot generated from the time-series data. In this case, the analysis device 20 need not include the generation unit 22.

The generation unit 22 generates a recurrence plot from the input time-series data. The method by which the generation unit 22 generates the recurrence plot is the same as the method by which the recurrence plot generation unit 12 generates the recurrence plot.

The result output unit 23 outputs an analysis result of the input time-series data using the feature extracted by the feature extraction unit 13. Specifically, the result output unit 23 outputs an analysis result that compares the feature extracted by the feature extraction unit 13 with the feature indicated by a recurrence plot generated from the time-series data.

The result output unit 23 may, for example, output the contents of the time-series data with similar features, or may output the probability of each of the predicted time-series data. Also, if a discriminative model has been generated by the feature extraction unit 13, the result output unit 23 may output a discriminative result by the discriminative model.

The analysis target input unit 21, the generation unit 22, and the result output unit 23 are realized by a processor of a computer that operates according to a program (analysis program).

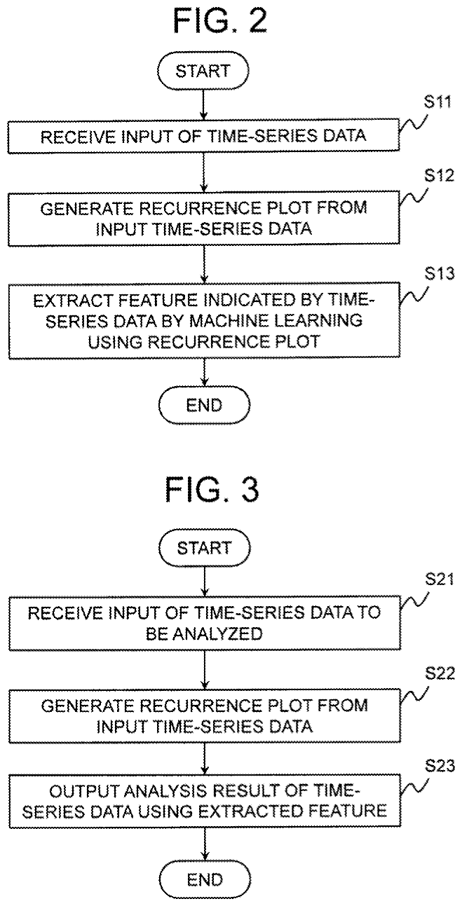

Next, the operation of the time-series data analysis system 100 of the present exemplary embodiment will be described. FIG. 2 is a flowchart showing an operation example of the feature extraction device 10 in the time-series data analysis system 100. Here, it is assumed that the input unit 11 receives input of time-series data.

The input unit 11 receives input of time-series data (step S11). The recurrence plot generation unit 12 generates a recurrence plot from the input time-series data (step S12). Then, the feature extraction unit 13 extracts a feature indicated by the time-series data by machine learning using the recurrence plot (step S13).

FIG. 3 is an explanatory diagram of an operation example of the analysis device 20 in the time-series data analysis system 100. An analysis target input unit 21 receives input of time-series data to be analyzed (step S21). The generation unit 22 generates a recurrence plot from the input time-series data (step S22). Then, the result output unit 23 outputs an analysis result of the input time-series data using the feature extracted by the feature extraction unit 13 (step S23).

As described above, in the present exemplary embodiment, the feature extraction unit 13 extracts a feature indicated by time-series data by machine learning using a recurrence plot generated from the time-series data. Thus, it is possible to extract a feature representing a global structure from time-series data.

In other words, in the present exemplary embodiment, the recurrence plot generation unit 12 generates a recurrence plot from time-series data, thereby visually obtaining information indicating the global structure of the time-series data, which enables the feature extraction unit 13 is able to extract a feature from a global perspective.

In addition, the present exemplary embodiment can extract a feature using image recognition techniques without going through the process of directly extracting a feature from time-series data composed of time and values at that time. Furthermore, the present exemplary embodiment can capture a feature of the time-series data that are not clarified by the general recurrence plot quantification method. Therefore, for example, even if the results obtained by the general quantification method are comparable and the recurrence plots are similar in human appearance, it is also possible to distinguish them from different time-series data.

Next, a specific example of the time-series data analysis system 100 of the present exemplary embodiment will be described. In this specific example, an operation of analyzing a type of communication being performed using traffic data on a network as time-series data will be described. The time-series data analysis system in this specific example can be referred to as a communication type analysis system.

First, prior to the analysis of the type of communication, the feature extraction device 10 extracts a feature from traffic data. First, the input unit 11 receives input of traffic data as learning data. In addition to the traffic data, the input unit 11 may also receive the input of the type of the traffic and the conditions for generating the recurrence plot.

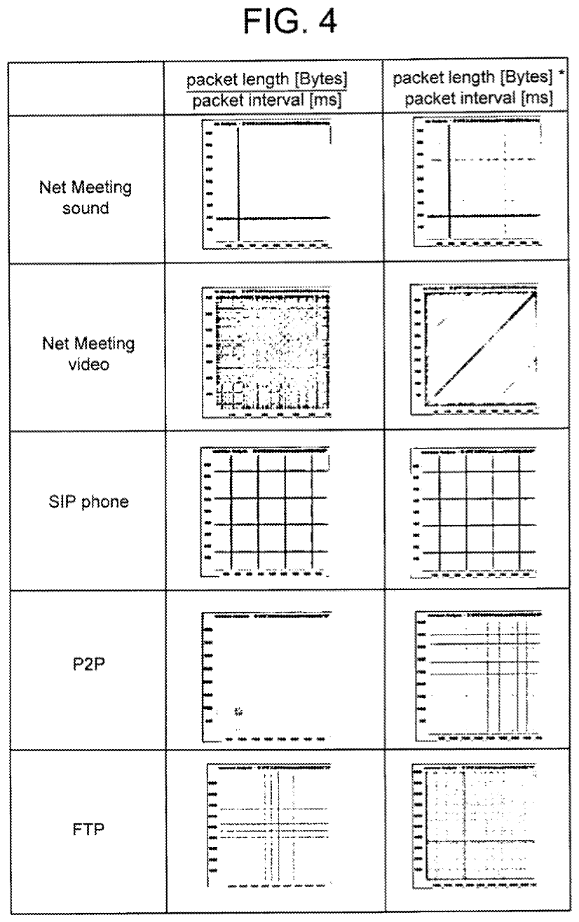

The recurrence plot generation unit 12 generates a recurrence plot from the received traffic data. FIG. 4 is an explanatory diagram showing an example of a recurrence plot. In the example shown in FIG. 4, the recurrence plot generation unit 12 generates a recurrence plot using the value of the input traffic data converted based on the length and interval of packets included in the traffic data.

Specifically, the left column illustrated in FIG. 4 is a recurrence plot generated based on the value obtained by dividing the packet length (Bytes) by the packet interval (ms). On the other hand, the right column illustrated in FIG. 4 is a recurrence plot generated based on the value obtained by multiplying the packet length (Bytes) and the packet interval (ms).

The feature extraction unit 13 extracts a feature of the traffic data by performing machine learning using the generated recurrence plot as image data. The feature extraction unit 13 may generate a discriminative model of the traffic data. Then, the feature extraction unit 13 stores the extracted feature and the discriminative model in the storage unit 14.

Next, the analysis device 20 performs analysis of the traffic data. First, the analysis target input unit 21 receives input of traffic data to be analyzed. Next, the generation unit 22 generates a recurrence plot from the input traffic data. Then, the result output unit 23 outputs an analysis result of the input traffic data using the feature extracted by the feature extraction unit 13.

The result output unit 23 may, for example, display the recurrence plot of the time-series data in some or all of the types illustrated in FIG. 4 together with the recurrence plot of the traffic data to be analyzed. This allows the analyst to visually confirm the similarity of the time-series data. Alternatively, the result output unit 23 may output a probability of the type of time-series data to be predicted.

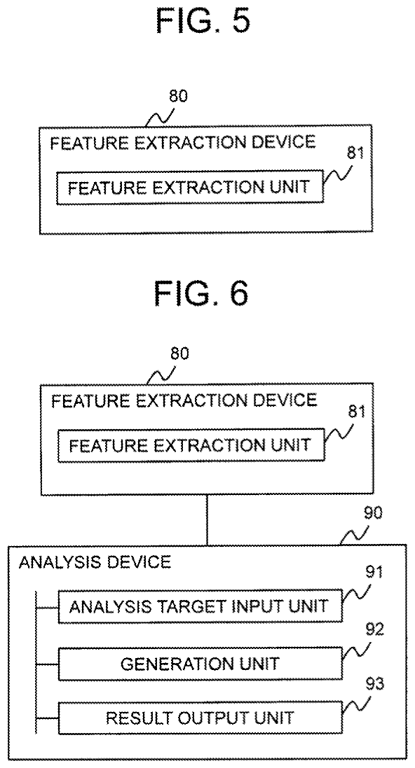

Next, an overview of the present invention will be described. FIG. 5 is a block diagram showing an overview of a feature extraction device according to the exemplary aspect of the present invention. A feature extraction device 80 (for example, feature extraction device 10) according to the exemplary aspect of the present invention comprises a feature extraction unit 81 (for example, feature extraction unit 13) which extracts a feature indicated by time-series data by machine learning using a recurrence plot generated from the time-series data.

With such a configuration, it is possible to extract a feature representing a global structure from time-series data.

The feature extraction unit 81 may extract the feature indicated by the time-series data by the machine learning using a plurality of recurrence plots generated for each of a plurality of conditions with different contents for the same time-series data. With such a configuration, it is possible to extract a feature considering a plurality of conditions for the same time-series data.

Specifically, the feature extraction unit 81 may extract the feature indicated by the time-series data by the machine learning using a plurality of recurrence plots generated based on conditions in which at least one condition of an embedding dimension or a delay amount is varied for the same time-series data.

The feature extraction device 80 may also comprise an input unit (for example, input unit 11) which receives input of the time-series data, and a recurrence plot generation unit (for example, recurrence plot generation unit 12) which generates the recurrence plot from the input time-series data. Then, the feature extraction unit 81 may extract the feature of the time-series data by performing the machine learning using the generated recurrence plot as image data.

FIG. 6 is a block diagram showing an overview of a time-series data analysis system according to the exemplary aspect of the present invention. A time-series data analysis system according to the exemplary aspect of the present invention (for example, time-series data analysis system 100) comprises a feature extraction device 80 illustrated in FIG. 5, and an analysis device 90 (for example, analysis device 20) which analyzes time-series data.

The analysis device 90 includes an analysis target input unit 91 (for example, analysis target input unit 21) which receives input of the time-series data to be analyzed, a generation unit 92 (for example, generation unit 22) which generates a recurrence plot from the time-series data, and a result output unit 93 (for example, result output unit 23) which outputs an analysis result of the input time-series data using a feature extracted by the feature extraction unit 81.

Even with such a configuration, it is possible to improve the accuracy of analyzing time-series data because a feature representing a global structure can be extracted from the time-series data.

The feature extraction unit 81 may extract the feature indicated by traffic data by machine learning using a recurrence plot generated from the traffic data which is the time-series data. Then, the analysis target input unit 91 may receive the input of the traffic data to be analyzed, the generation unit 92 may generate the recurrence plot from the traffic data, and the result output unit 93 may output the analysis result of the input traffic data using the feature extracted by the feature extraction unit 81.

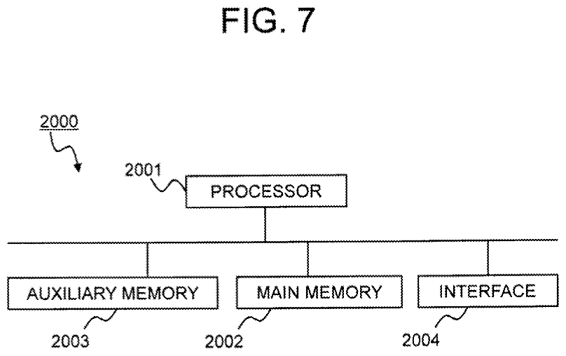

FIG. 7 is a summarized block diagram showing a configuration of a computer for at least one exemplary embodiment. The computer 1000 comprises a processor 1001, a main memory 1002, an auxiliary memory 1003, and an interface 1004.

The above-described feature extraction device 80 is implemented in a computer 1000. The operation of each of the above-described processing parts is stored in the auxiliary memory 1003 in the form of a program (feature extraction program). The processor 1001 reads the program from the auxiliary memory 1003, develops it to the main memory 1002, and executes the above-described processing according to the program.

In at least one exemplary embodiment, the auxiliary memory 1003 is an example of a non-transitory tangible medium. Other examples of a non-transitory tangible medium include a magnetic disk, an optical magnetic disk, a CD-ROM (Compact Disc Read-only memory), a DVD-ROM (Read only memory), semiconductor memory, and the like connected through interface 1004. When the program is delivered to the computer 1000 through a communication line, the computer 1000 receiving the delivery may extract the program into the main memory 1002 and execute the above processing.

The program may be a program for realizing a part of the above-described functions. Further, the program may be a so-called difference file (difference program) that realizes the aforementioned functions in combination with other programs already stored in the auxiliary memory 1003.

A part of or all of the above exemplary embodiments may also be described as, but not limited to, the following supplementary notes.

(Supplementary note 1) A feature extraction device comprising

a feature extraction unit which extracts a feature indicated by time-series data by machine learning using a recurrence plot generated from the time-series data.

(Supplementary note 2) The feature extraction device according to Supplementary note 1, wherein

the feature extraction unit extracts the feature indicated by the time-series data by the machine learning using a plurality of recurrence plots generated for each of a plurality of conditions with different contents for the same time-series data.

(Supplementary note 3) The feature extraction device according to Supplementary note 1 or Supplementary note 2, wherein

the feature extraction unit extracts the feature indicated by the time-series data by the machine learning using a plurality of recurrence plots generated based on conditions in which at least one condition of an embedding dimension or a delay amount is varied for the same time-series data.

(Supplementary note 4) The feature extraction device according to any one of Supplementary notes 1 to 3, further comprising:

an input unit which receives input of the time-series data; and

a recurrence plot generation unit which generates the recurrence plot from the input time-series data, wherein

the feature extraction unit extracts the feature of the time-series data by performing the machine learning using the generated recurrence plot as image data.

(Supplementary note 5) A time-series data analysis system comprising:

the feature extraction device according to any one of claims 1 to 4; and

an analysis device which analyzes time-series data,

wherein the analysis device includes:

an analysis target input unit which receives input of the time-series data to be analyzed;

a generation unit which generates a recurrence plot from the time-series data; and

a result output unit which outputs an analysis result of the input time-series data using a feature extracted by the feature extraction unit.

(Supplementary note 6) The time-series data analysis system according to Supplementary note 5, wherein

the feature extraction unit extracts the feature indicated by traffic data by machine learning using a recurrence plot generated from the traffic data which is the time-series data,

the analysis target input unit receives the input of the traffic data to be analyzed,

the generation unit generates the recurrence plot from the traffic data, and

the result output unit outputs the analysis result of the input traffic data using the feature extracted by the feature extraction unit.

(Supplementary note 7) A feature extraction method by a computer, comprising

extracting a feature indicated by time-series data by machine learning using a recurrence plot generated from the time-series data.

(Supplementary note 8) The feature extraction method according to Supplementary note 7, further comprising

extracting the feature indicated by the time-series data by the machine learning using a plurality of recurrence plots generated for each of a plurality of conditions with different contents for the same time-series data.

(Supplementary note 9) A time-series data analysis method comprising:

extracting a feature indicated by time-series data by a feature extraction method according to Supplementary note 7 or Supplementary note 8;

receiving input of the time-series data to be analyzed;

generating a recurrence plot from the time-series data; and

outputting an analysis result of the input time-series data using the extracted feature.

(Supplementary note 10) The time-series data analysis method according to Supplementary note 9, further comprising:

extracting the feature indicated by traffic data by machine learning using a recurrence plot generated from the traffic data which is the time-series data;

receiving the input of the traffic data to be analyzed;

generating the recurrence plot from the traffic data; and

outputting the analysis result of the input traffic data using the extracted feature.

(Supplementary note 11) A feature extraction program causing a computer to execute

a feature extraction process of extracting a feature indicated by time-series data by machine learning using a recurrence plot generated from the time-series data.

(Supplementary note 12) The feature extraction program according to Supplementary note 11, causing the computer to execute

extracting the feature indicated by the time-series data by the machine learning using a plurality of recurrence plots generated for each of a plurality of conditions with different contents for the same time-series data, in the feature extraction process.

### REFERENCE SIGNS LIST

10 Feature extraction device
11 Input unit
12 Recurrence plot generation unit
13 Feature extraction unit
14 Storage unit
20 Analysis device
21 Analysis target input unit
22 Generation unit
23 Result output unit

What is claimed is:

1. A feature extraction device comprising:
a memory storing instructions; and
one or more processors configured to execute the instructions to
extract a feature indicated by time-series data by machine learning using a recurrence plot generated from the time-series data.

2. The feature extraction device according to claim 1, wherein the processor further executes instructions to
extract the feature indicated by the time-series data by the machine learning using a plurality of recurrence plots generated for each of a plurality of conditions with different contents for the same time-series data.

3. The feature extraction device according to claim 1, wherein the processor further executes instructions to
extract the feature indicated by the time-series data by the machine learning using a plurality of recurrence plots generated based on conditions in which at least one condition of an embedding dimension or a delay amount is varied for the same time-series data.

4. The feature extraction device according to claim 1, wherein the processor further executes instructions to:
receive input of the time-series data;
generate the recurrence plot from the input time-series data; and
extract the feature of the time-series data by performing the machine learning using the generated recurrence plot as image data.

5. A time-series data analysis system comprising:
the feature extraction device according to claim 1; and
an analysis device which analyzes time-series data,
wherein the analysis device includes:
an analysis target input unit which receives input of the time-series data to be analyzed;
a generation unit which generates a recurrence plot from the time-series data; and
a result output unit which outputs an analysis result of the input time-series data using a feature extracted by the feature extraction unit.

6. The time-series data analysis system according to claim 5, wherein
the feature extraction unit extracts the feature indicated by traffic data by machine learning using a recurrence plot generated from the traffic data which is the time-series data,
the analysis target input unit receives the input of the traffic data to be analyzed,
the generation unit generates the recurrence plot from the traffic data, and
the result output unit outputs the analysis result of the input traffic data using the feature extracted by the feature extraction unit.

7. A feature extraction method by a computer, comprising
extracting a feature indicated by time-series data by machine learning using a recurrence plot generated from the time-series data.

8. The feature extraction method according to claim 7, further comprising
extracting the feature indicated by the time-series data by the machine learning using a plurality of recurrence plots generated for each of a plurality of conditions with different contents for the same time-series data.

9. A time-series data analysis method comprising:
extracting a feature indicated by time-series data by the feature extraction method according to claim 7;
receiving input of the time-series data to be analyzed;
generating a recurrence plot from the time-series data; and
outputting an analysis result of the input time-series data using the extracted feature.

10. The time-series data analysis method according to claim 9, further comprising:
extracting the feature indicated by traffic data by machine learning using a recurrence plot generated from the traffic data which is the time-series data;
receiving the input of the traffic data to be analyzed;
generating the recurrence plot from the traffic data; and
outputting the analysis result of the input traffic data using the extracted feature.

11. A non-transitory computer readable information recording medium storing a feature extraction program, when executed by a processor, that performs a method for
extracting a feature indicated by time-series data by machine learning using a recurrence plot generated from the time-series data.

12. The non-transitory computer readable information recording medium according to claim 11, further comprising
extracting the feature indicated by the time-series data by the machine learning using a plurality of recurrence plots generated for each of a plurality of conditions with different contents for the same time-series data.
